(19) United States
(12) Patent Application Publication
(10) Pub. No.: US 2015/0012310 A1
(43) Pub. Date: Jan. 8, 2015

(54) Taxi Calling System and Method Based on Handheld Mobile Terminals

(71) Applicant: Zhe SHEN, (US)

(72) Inventor: Zhe Shen, Shijiazhuang (CN)

(21) Appl. No.: 14/380,891

(22) PCT Filed: Jan. 15, 2013
(86) PCT No.: PCT/CN2013/070438

§ 371 Date: Aug. 25, 2014

(30) Foreign Application Priority Data
Feb. 26, 2012 (CN) 201210043953.7

(51) Int. Cl. G06Q 10/02

(52) U.S. Cl. CPC G06Q 10/02; G06Q 50/30
USPC 705/5

(57) ABSTRACT

The taxi calling system and methods based on the handheld mobile terminal aims at resolving passengers' difficulty of calling a taxi, waste of traffic resource and the platform promotion of taxi calling system. This system contains the hand-held mobile terminal of the passengers, information processing server and the handheld mobile server of the driver. The information procession server can receive and save the dynamic geographic location information of the driver's hand-held mobile terminal. The passengers use handheld mobile terminal to send order information that includes location information to the information processing server which will send request information to the driver's handheld mobile terminal within the relevant area of the passenger. After the drivers receive the request information, they can grab the request, contact the passenger through voice or symbol communication under the coordination of information processing server, confirm the request affairs and finally provide carrying for the passenger. This system and method is convenient for passengers to lower empty rate of taxis and is easy to promote.

### BACKGROUND OF THE PRESENT INVENTION

1. Field of Invention

This invention relates to a taxi call system and method, especially relates to the taxi call system and method which are based on hand-held mobile terminals.

2. Description of Related Arts

In order to solve the problems such as the strict requirements about the entrance of taxi dispatch system, the high cost of putting the dispatch system into practice, the great difficulty in spreading the dispatch system, the difficulty for passengers to take a taxi, the waste of traffic resources and so on, many kinds of taxi call systems come into being accordingly.

The patent document whose public No. is CN101547417 publicized a kind of network taxi call system, which consists of a call centre and several branch call centers. The branch call centers are connected with the call centre through VPN or ATM and DDN. The call centre and branch call centers are connected with the local mobile communication networks by simulation and digital trunk respectively. Every branch call centre is only in charge of switching the customer's calls and taxi registrations in each branch area to the call centre while the call centre is in charge of dealing with transactions about mobile positioning of customer's calls from all the areas, searching taxis, transferring calls, authentication and registration as well as mobile positioning of cars and receiving customer's calls and so on.

There are still some disadvantages about the above-mentioned taxi call systems, such as the complex systems, the high operating costs and their demand of workers on duty and so on, so they can't meet our actual needs efficiently.

The patent document whose public No. is CN102158803 publicized a taxi call system and method which are based on mobile terminals and consist of hand-held mobile terminals, information management server and vehicle mobile terminals. The use of the hand-held mobile terminals is to send information about users' current positions to the information management server; as for the information management server, it's used to receive information about current positions and then transform it into broadcast information and then send it to the vehicle mobile terminals; as for the vehicle mobile terminals, they're used to receive broadcast information in that area as well as to display the current positions of the hand-held mobile terminals. The passengers use the hand-held mobile terminals to send their current positions to the information management server; The information management server sends broadcast information which is in accordance with its location to all the taxis in that area; the taxis receive the broadcast information in that region and the go to passengers' locations to pick up them.

The vehicle mobile terminals require the drivers to receive orders in taxi and bind the drivers and taxis they drive together, what's more, the above mentioned taxi call method will easily cause several taxis to go to the same passenger's location, which then will lead to the waste of traffic resources, besides, the inconveniences caused by the error of the positioning system cannot be ignored as well.

### SUMMARY OF THE PRESENT INVENTION

In order to solve the shortcomings of the current technology, this invention aims to provide a taxi call system and method which are based on hand-held mobile terminals, the passengers can use their hand-held mobile terminals which they carry with them and meet the system's requirements to send the information about taxi-taking, the set of the grab-order system for the drivers provides an efficient and convenient ride, which avoids the unnecessary waste of resources. The information processing server helps drivers and passengers realize the vocal or symbolic communications and then drivers can rapidly confirm passengers' locations and then go to pick them up. Moreover, the drivers are not just limited to the taxis they drive any longer during the use of this system, which can avoid such case that many drives have to stay in taxis for a long time in order to receive orders, the drivers can grab and receive orders efficiently even when they are having rests in streets, besides, this system is implemented by the hand-held mobile terminals between drivers and passengers, which greatly reduced the receiving cost and the spreading difficulty of the taxi call platforms.

In order to realize the above-mentioned purposes, the taxi call system in this invention which is based on the hand-held mobile terminals includes: passenger's hand-held mobile terminals, information processing server and driver's hand-held mobile terminals, and among which:
(1) The handheld mobile terminal of the passenger can send order information to information processing server, receive the driver's identification information sent by information processing server, can carry on voice or symbol communication according to the above-mentioned driver identification information and driver's handheld mobile terminal. The order information contains the geographic location information of the passenger and also the communication information of the passenger, the communication way includes voice or symbol method, the driver identification information contains the voice or symbol communication identification information within the system and the communication way information of the driver. The communication way contains voice or symbol way;
(2) Information processing server can receive and store the dynamic geography information sent by the handheld mobile terminal of the driver, driver's information on communication mode sent by driver's handheld mobile terminal, order information sent by passengers' handheld mobile terminal, can generate passenger regional information according to the described geographic location information in the order information, can send taxi request information to the handheld mobile terminal within this region according to passenger regional information, can receive the order grabbing information sent by the handheld mobile terminal of the driver, can make choices according to order grabbing operation information and get handheld mobile terminal collection of drivers allowed to receive the order, can send passenger identification information to every driver' handheld mobile terminal, can send the driver's identification information described in driver's handheld mobile terminal to the passenger's handheld mobile terminal. The passenger identification information contains the communication mode information of the passenger or the identification information used for voice or symbol communication within the system by the passenger.
(3) The handheld mobile terminal of the passenger can send described dynamic location information to the information processing server, can send the driver's communication information to the information processing server, can receive request information sent by information processing server, can send order grabbing information to information processing server according to request information, can receive passenger's identification information sent by the information processing server, and can carry on voice or symbol communication according to received passenger identification information and the passenger's handheld mobile terminal.

In order to realize the above-mentioned purposes, the procedures of the taxi call method of this invention which are based on hand-held mobile terminals are as follows:
(1) The driver's handheld mobile terminal sends the dynamic location information to the information processing server;
(2) Information processing server receives and stores the dynamic location information sent by the driver's handheld mobile terminal;
(3) The passengers use their handheld mobile terminal to send order information to information processing server. The described order information contains passenger's location information and also communication mode information of the passenger; the communication mode contains voice or symbol mode;
(4) information processing server receives order information sent by handheld mobile terminal of the passenger, then generates passenger regional information according to location information of the passenger, and send request information to the handheld mobile terminal of the drivers according to the regional information of the passenger;
(5) The handheld mobile terminal of the driver receives the request information sent by the information processing server;
(6) The drivers use their handheld mobile termination to send order grabbing information to information processing server according to received request information, and send their communication mode information to information processing server, the communication mode includes voice or symbol mode;
(7) The information processing server makes choices according to order grabbing information, and gets the collection of the handheld mobile terminals of drivers allowed to accept order, send the identification information to the drivers' handheld mobile terminal, and then send the driver's identification information to the handheld mobile terminal of the passenger. The described passenger identification information contains the passenger's communication mode information or identification information used for voice or symbol communication within the system. The described driver identification information contains the driver's communication mode information or identification information used for voice or symbol communication within the system of the driver's handheld mobile terminal.
(8) The driver carries on voice or symbol communication with the passenger, confirms the carrying location, and drives to carry the passenger.

### BRIEF DESCRIPTION OF THE DRAWINGS

The appended drawings are used for further understanding on this invention and constitute part of the instruction book. Meanwhile, they are used to explain this invention with the implementation cases, while will not constitute limitation of this invention. In the appended drawings:

FIG. 1 (Drawing 1) is the taxi calling system schematic diagram based on handheld mobile terminal related to this invention;

FIG. 2 (Drawing 2) is the taxi calling method schematic diagram based on handheld mobile terminal related to this invention;

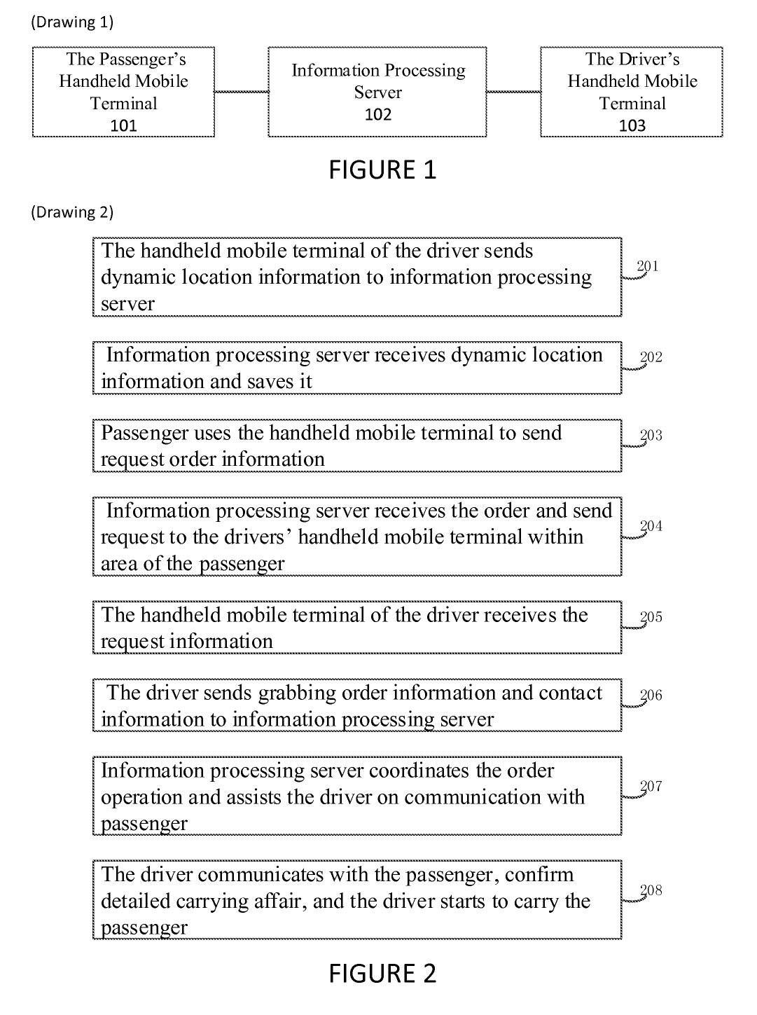

### DETAILED DESCRIPTION OF THE PREFERRED EMBODIMENT

The optimization implementation cases of this invention are explained by combining with appended drawings. It should be mentioned that the prior implementation cases described hereby are only used for instruction and explanation on this invention while not used for limiting this invention.

Drawing 1 is the taxi calling system schematic diagram based on handheld mobile terminal related to this invention. As the Drawing 1 shows, this system contains the passenger's handheld mobile terminal 101, information processing server 102 and the driver's handheld mobile terminal 103.

The passenger's handheld mobile terminal 101 can send the order information that contains the calling location coordinate of passenger and the contact number of the passenger to the information processing server 102, can receive the voice or symbol communication identification information used within the system by the driver's handheld mobile terminal 103, and the driver identification information containing the driver's contact number sent by information processing server 102, can carry on voice communication with the driver's handheld mobile terminal 103 according to identification information or the driver's contact telephone in the driver identification information.

Information processing server 102 can receive and store the dynamic geographic information sent by the driver's handheld mobile terminal 103, can receive the driver's contact phone number sent by the driver's handheld mobile terminal 103, can receive the calling order information sent by the passenger's handheld mobile terminal 101, can generate regional information for area within one kilometer away from the passenger according to the calling location coordinate in the order information, can send request information to the drivers' handheld mobile terminal 103 within this region according to regional information of the passenger, can receive the order grabbing operation information including grabbing time sent by the drivers' handheld mobile terminal 103, can choose the handheld mobile terminal 103 of driver who grabs the order firstly according to the received grabbing order information, can send the identification information used for voice or symbol communication in the system and passenger identification information containing the contact phone number of the passenger to the first driver's handheld mobile terminal 103, can send the driver identification information described in handheld mobile terminal 103 of the driver who firstly grab the order to passenger's handheld mobile terminal 101.

The driver's handheld mobile terminal 103 can send described dynamic location information to information processing server 102, can send the driver's contact number to the information processing server 102, can receive the request information sent by the information processing server 102, can send described grabbing order information to information processing server 102 according to call-taxi request information, can receive the described passenger identification information sent by information processing server 102, can carry on voice communication with the handheld mobile terminal 101 of the passenger according to received identification information or contact number in the passenger identification information.

Drawing 2 is the taxi calling method flow chart based on handheld mobile terminal of this invention. Now specific description is given for the taxi calling method flow chart based on handheld mobile terminal:

At step 201, the handheld mobile terminal of the driver 103 sends its location information to the information processing server 102 automatically every 20 seconds.

At step 202, information processing server 102 receives and stores the dynamic location information sent by the driver's handheld mobile terminal 103;

At step 203, the passengers use their handheld mobile terminal 101 to send order information to the information processing server 102, and the described order information contains the passenger's location coordinate and the contact number of the passenger;

At step 204, information processing server 102 receives the order information sent by the passenger's handheld mobile terminal 101, and generates the regional information for area within one kilometer away from the passenger according to the calling location coordinate in the order information, and send call-taxi request information to the drivers' handheld mobile terminal 103 within this area according to passenger's regional information;

At step 205, the driver's handheld mobile terminal 103 within the passenger's region receives the call-taxi request information sent by information processing server 102;

At step 206, the drivers use their handheld mobile terminal 103 to send grabbing order information to the information processing server 102 according to received call-taxi request information, and send the drivers' contact numbers to the information processing server 102;

At step 207, the information processing server 102 makes optimization selection according to received grabbing order information, gets the handheld mobile terminal 103 of driver who firstly grabs the order, and sends identification information used for voice or symbol communication within the system and passenger identification information containing passenger's contact number to the handheld mobile terminal 103 of the above-mentioned first driver, and sends the driver's identification information used for voice or symbol communication and the driver's contact number to the passenger's handheld mobile terminal 101;

At step 208, the driver contacts the passenger actively according to described passenger identification information, or the passenger contacts the driver actively according to driver identification information. Then the driver conducts voice or symbol communication with the passenger. At last, the driver confirms the passenger's location and drives to carry the passenger.

Taxi calling system and methods based on the hand-held mobile terminal can help the passengers to contact taxis around and therefore satisfies the passenger's need for trip, and lower the empty-run rate of taxis. The driver can conduct grabbing order out of taxi, so the design based on handheld mobile terminal has greatly reduced the operation cost of the taxi calling system and promoted the promotion of taxi calling service platform.

Content mentioned above is only optimization implementation case of this invention while should not be used for limitation on this invention. Any modification, equivalent replacement and improvement, etc. made within this invention's spirit and principle should be included in the protection scope of this invention.

One of the defects that this invention have is that the design (which uses the driver's handheld mobile terminal 103 to replace traditional vehicle-mounted mobile terminal) cannot make automatic judgment for whether the taxi is empty or not, which lowered the sending target when the information processing server 102 sends call-taxi request information. However, we can set switch buttons in the driver's handheld mobile terminal 103, if this button is open, then the driver's handheld mobile terminal can receive request information, and if this button is closed, the driver's handheld mobile terminal cannot receive calling request information. Thus this defect can be improved to some extent.

This invention can be improved further. For example, the information processing server 102 can send more plentiful information about the driver and vehicle to the passenger's handheld mobile terminal 101, and the information processing server 102 can also send more plentiful passenger basic information to the driver's handheld mobile terminal 103. The above-mentioned information about driver and vehicle can include one or more of the driver's name, the vehicle number, available seat number of the vehicle, color of the vehicle, brand of the vehicle and model; the passenger basic information can include one or more of the rough information about the passenger's location, number of passengers or destination of the passenger.

This invention can be further improved. The driver's handheld mobile terminal 103 can send allowed request scope information to information processing server 102, and information processing server 102 can send call-taxi request information within this scope to the driver's handheld mobile terminal 103. The described allowed request scope information refers to that the driver agrees to receive the call-taxi geographic information of the passenger.

Any modification, equivalent replacement and improvement that are based on the above-mentioned defect and aspect needing improvement should all be included in the protection scope of this invention.

What is claimed is:

1. The taxi calling system and methods based on the hand-held mobile terminal contains the handheld mobile terminal of the passenger, information processing server and the handheld mobile terminal of the driver. Its characteristics are:
(1) The handheld mobile terminal of the passenger can send order information to information processing server, receive the driver's identification information sent by information processing server, can carry on voice or symbol communication according to the above-mentioned driver identification information and driver's handheld mobile terminal. The order information contains the geographic location information of the passenger and also the communication information of the passenger, the communication way includes voice or symbol method, the driver identification information contains the voice or symbol communication identification information within the system and the communication way information of the driver. The communication way contains voice or symbol way;
(2) Information processing server can receive and storethe dynamic geography information sent by the handheld mobile terminal of the driver, driver's information on communication mode sent by driver's handheld mobile terminal, order information sent by passengers' handheld mobile terminal, can generate passenger regional information according to the described geographic location information in the order information, can send taxi request information to the handheld mobile terminal within this region according to passenger regional information, can receive the order grabbing information sent by the handheld mobile terminal of the driver, can make choices according to order grabbing operation information and get handheld mobile terminal collection of drivers allowed to receive the order, can send passenger identification information to every driver' handheld mobile terminal, can send the driver's identification information described in driver's handheld mobile terminal to the passenger's handheld mobile terminal. The passenger identification information contains the communication mode information of the passenger or the identification information used for voice or symbol communication within the system by the passenger.
(3) The handheld mobile terminal of the passenger can send described dynamic location information to the information processing server, can send the driver's communication information to the information processing server, can receive request information sent by information processing server, can send order grabbing information to information processing server according to request information, can receive passenger's identification information sent by the information processing server, and can carry on voice or symbol communication according to received passenger identification information and the passenger's handheld mobile terminal.

2. The taxi calling methods based on the handheld mobile terminal contains steps as follows:
(1) The driver's handheld mobile terminal sends the dynamic location information to the information processing server;
(2) Information processing server receives and stores the dynamic location information sent by the driver's handheld mobile terminal;
(3) The passengers use their handheld mobile terminal to send order information to information processing server. The described order information contains passenger's location information and also communication mode information of the passenger; the communication mode contains voice or symbol mode;
(4) information processing server receives order information sent by handheld mobile terminal of the passenger, then generates passenger regional information according to location information of the passenger, and send request information to the handheld mobile terminal of the drivers according to the regional information of the passenger;
(5) The handheld mobile terminal of the driver receives the request information sent by the information processing server;
(6) The drivers use their handheld mobile termination to send order grabbing information to information processing server according to received request information, and send their communication mode information to information processing server, the communication mode includes voice or symbol mode;
(7) The information processing server makes choices according to order grabbing information, and gets the collection of the handheld mobile terminals of drivers allowed to accept order, send the identification information to the drivers' handheld mobile terminal, and then send the driver's identification information to the handheld mobile terminal of the passenger. The described passenger identification information contains the passenger's communication mode information or identification information used for voice or symbol communication within the system. The described driver identification information contains the driver's communication mode information or identification information used for voice or symbol communication within the system of the driver's handheld mobile terminal.
(8) The driver carries on voice or symbol communication with the passenger, confirms the carrying location, and drives to carry the passenger.
